(19) United States
(12) Patent Application Publication
(10) Pub. No.: US 2012/0002737 A1
(43) Pub. Date: Jan. 5, 2012

(54) Method and Apparatus for Coexistence of OFDM Receiver with Burst Interference

(75) Inventor: Miika Tupala, Turku (FI)

(73) Assignee: NOKIA CORPORATION, Espoo (FI)

(21) Appl. No.: 13/255,082

(22) PCT Filed: Mar. 6, 2009
(86) PCT No.: PCT/FI09/50183

§ 371 Date: Sep. 6, 2011

(51) Int. Cl. H04L 27/00

(52) U.S. Cl. 375/259

(57) ABSTRACT

In accordance with an example embodiment of the present invention, an apparatus and a corresponding method are described, comprising reception of an orthogonal frequency division multiplexing (OFDM) transmission, wherein the OFDM transmission comprises at least one OFDM symbol and at least one guard interval. At least a part of the OFDM symbol is repeated during at least a part of the guard interval. The presence of a burst interference is detected, and at least a part of the OFDM symbol occurring during the burst interference is replaced with at least a part of the signal received during the guard interval.

### TECHNICAL FIELD

The present application relates generally to reception of an Orthogonal Frequency Division Multiplexing (OFDM) signal and reduction of the effect of interference from a burst interferer.

### BACKGROUND

As the usage and the density of cordless and cellular transmitters increase, interference is more and more an issue. For example, there may be an overlap in transmission frequencies, or the transmission bands are close together so that channel separation at a receiver may become prohibitively expensive, if not impossible.

An apparatus may contain more than one transmitter and receiver. Due to the proximity within the device, interference may occur in receivers even if the active transmitter is not transmitting in an overlapping band, but is transmitting in a close transmission band. In addition, harmonics and mixing products may also occur and induce interference that falls into or close to a wanted transmission band of a receiver.

Burst interferers may be transmitters of cellular systems using time division duplex (TDD) and/or time division multiple access (TDMA) methods. Transmission of such systems may occur at regular intervals and interfere with other systems during the burst transmissions.

An example of a cellular system using TDMA is the Global System for Mobile communication (GSM). A mobile device may have a GSM transceiver integrated with a mobile broadcast receiver, for example a mobile television (mobile TV) receiver such as a Digital Video Broadcasting receiver for terrestrial (DVB-T) or handheld (DVB-H) reception. The DVB systems use Orthogonal Frequency Division Multiplexing (OFDM) technology. Some GSM transmission bands are close to the upper end of the DVB transmission band. Therefore, interference from the GSM transmitter to the DVB receiver may occur.

### SUMMARY

Various aspects of examples of the invention are set out in the claims.

According to a first aspect of the present invention, an apparatus is disclosed, comprising a receiver configured to receive an OFDM transmission, wherein the OFDM transmission comprises at least one OFDM symbol and at least one guard interval. At least a part of the OFDM symbol is repeated during at least a part of the guard interval. The apparatus further comprises a detection unit configured to detect the presence of a burst interference, and a control unit configured to replace at least a part of the OFDM symbol occurring during the burst interference with at least a part of the signal received during the guard interval.

According to a second aspect of the present invention, a method is described, comprising receiving an OFDM transmission comprising at least one OFDM symbol and at least one guard interval, wherein at least a part of the OFDM symbol is repeated during at least a part of the guard interval. The method further comprises detecting the presence of a burst interference; and replacing at least a part of the OFDM symbol occurring during the burst interference with at least a part of the signal received during the guard interval.

According to a third aspect of the present invention, a computer program, a computer program product and a computer-readable medium storing the computer program are disclosed, the computer program comprising code for receiving an OFDM transmission comprising at least one OFDM symbol and at least one guard interval, wherein at least a part of the OFDM symbol is repeated during at least a part of the guard interval. The computer program comprises further code for detecting the presence of a burst interference, and code for replacing at least a part of the OFDM symbol occurring during the burst interference with at least a part of the signal received during the guard interval, when the computer program is run on a processor.

According to a fourth aspect of the present invention, an apparatus is disclosed, comprising means for receiving an OFDM transmission, wherein the OFDM transmission comprises at least one OFDM symbol and at least one guard interval. At least a part of the OFDM symbol is repeated during at least a part of the guard interval. The apparatus further comprises means for detecting the presence of a burst interference, and means for replacing at least a part of the OFDM symbol occurring during the burst interference with at least a part of the signal received during the guard interval.

### BRIEF DESCRIPTION OF THE DRAWINGS

For a more complete understanding of example embodiments of the present invention, reference is now made to the following descriptions taken in connection with the accompanying drawings in which:

FIG. 1a shows a system with an apparatus according to an example embodiment of the invention;

FIG. 1b shows a system with an apparatus comprising a transmitter according to an example embodiment of the invention.

FIG. 2 shows an example embodiment of a transmission frame of a TDMA system;

FIG. 3 shows an example relation of the transmission bursts of FIG. 2 to symbols of an OFDM system;

FIG. 4 shows an example embodiment of an OFDM symbol with a related guard interval;

FIG. 5 shows an example embodiment of a spectrum of an interference situation between a transmitter and a receiver of a broadcast system;

FIG. 6 shows an example embodiment of a transmitter in close vicinity to a receiver configured to receive an OFDM transmission;

FIG. 7 shows a of a block diagram of an OFDM receiver according to an example embodiment of the invention;

FIG. 8 shows a block diagram of an OFDM receiver according to another example embodiment of the invention;

FIG. 9 shows a signal at example processing stages of a receiver according to an embodiment of the invention;

FIG. 10 shows a flowchart of a process for an example embodiment of the invention;

FIG. 11 shows a graph of a simulation result of an apparatus according to an example embodiment of the invention in comparison to a conventional receiver; and

FIG. 12 shows an apparatus comprising an OFDM receiver according to an example embodiment of the invention.

### DETAILED DESCRIPTION OF THE DRAWINGS

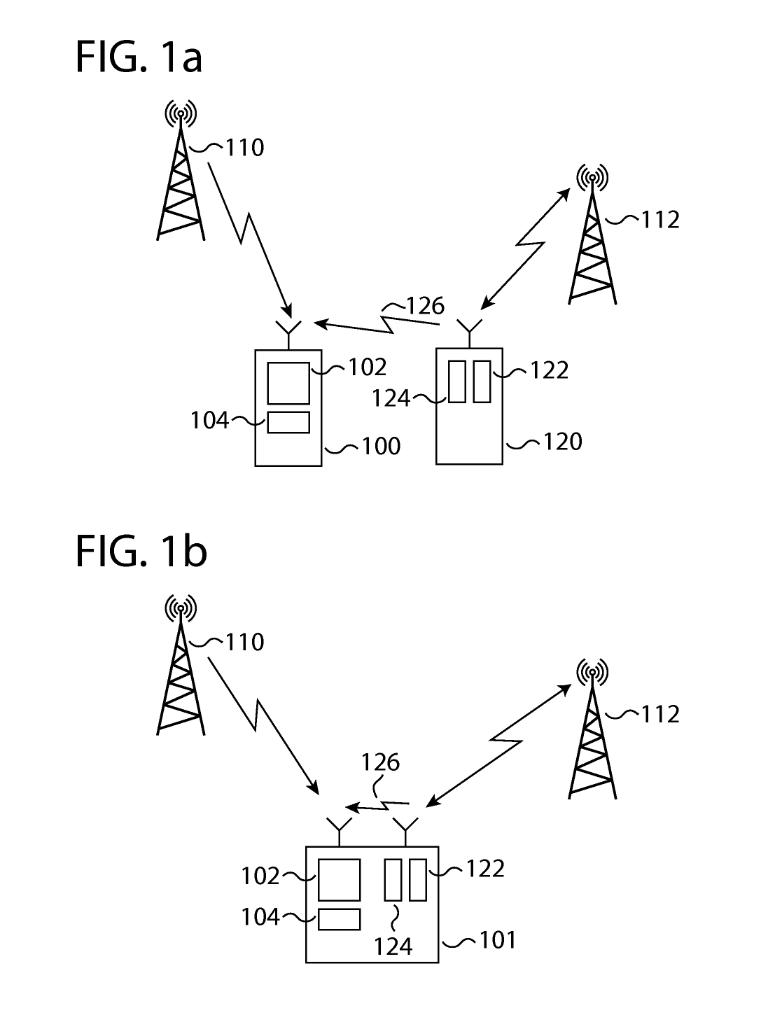

An example embodiment of the present invention and its potential is repeated during at least a part of the guard interval; advantages are understood by referring to FIGS. 1a through 12 of the drawings.

FIG. 1a shows a system with an apparatus 100 according to an example embodiment of the invention. Apparatus 100 comprises a receiver 102 configured to receive an OFDM transmission, for example a transmission from transmitter 110. The transmission may be a digital television transmission, for example according to the DVB-T, DVB-H, or DVB-NGH (next generation handheld) standard, or the ISDB-T (Integrated Services Digital Broadcasting-Terrestrial) standard. Apparatus 100 may further comprise a detection unit 104 configured to detect the presence of an interference. Detection unit 104 may also detect the timing of the interference, for example when the interference is in a burst mode that may be caused by a TDD or TDMA transmission.

Apparatus 120 in close vicinity to apparatus 100 may comprise a transmitter 122 and a receiver 124. Transmitter 122 and receiver 124 may utilize a TDD and/or TDMA transmission system. Transmitter 122 transmits data in bursts at regular or irregular intervals. The TDD and/or TDMA system may be a cellular system like GSM, Digital Advanced Mobile Phone System (D-AMPS), Personal Digital Cellular (PDC), integrated Digital Enhanced Network (iDEN) and Personal Handy-phone System (PHS), 3^{rd} generation systems like Universal Mobile Telecommunications System (UMTS-TDD), a cordless system like the Digital Enhanced Cordless Telecommunication (DECT) standard, or the like.

Detection unit 104 of apparatus 100 may detect a burst interference caused by transmitter 122 of apparatus 120.

FIG. 1b shows a system with an apparatus 101 comprising a transmitter according to an example embodiment of the invention. Apparatus 101 may comprise receiver 102, detection unit 104 and transmitter 122. Detection unit 104 may detect an activity of transmitter 122, indicating that an interference situation may occur. Thus, detection unit 104 may detect a burst interference caused by transmitter 122 of apparatus 101. For example, transmitter 122 may indicate by a signal to the detection unit 104 that it is actively transmitting.

In an example embodiment, apparatus 100, 101 is a mobile device, for example a mobile phone, comprising a digital television receiver 102, a cellular transceiver comprising transmitter 122 and receiver 124.

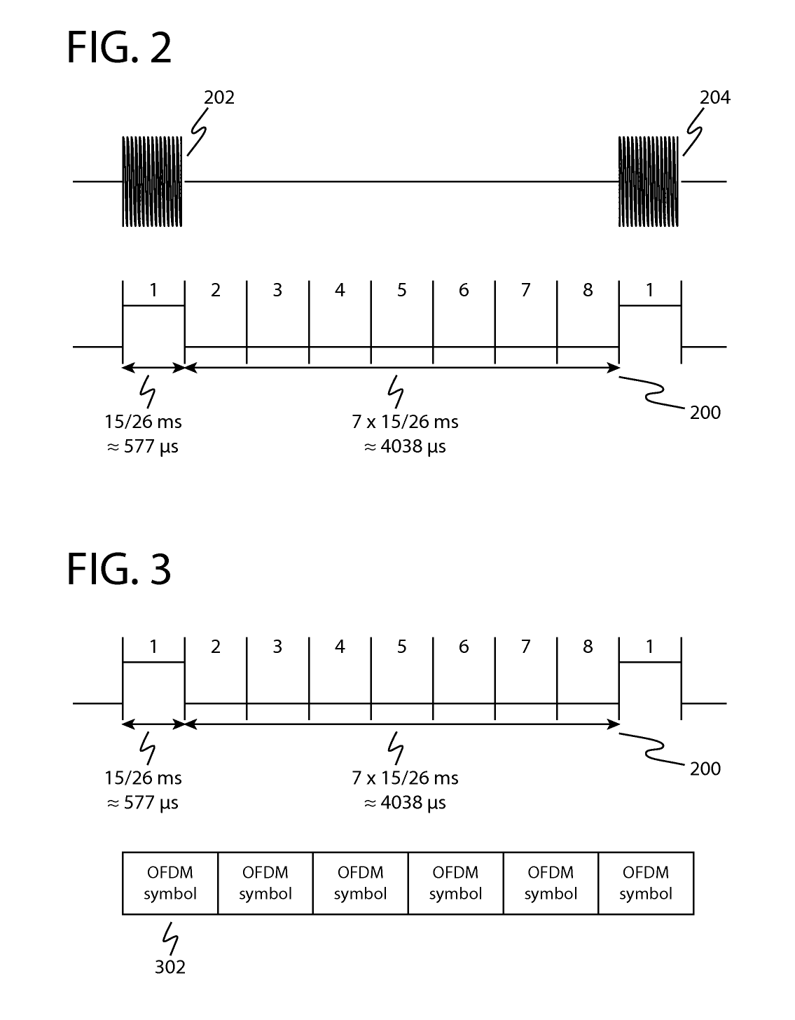

FIG. 2 shows an example embodiment of a transmission frame of a TDMA system, for example of a GSM system. Transmission frame 200 comprises 8 slots (numbered 1 to 8), each slot of a length of approximately 577 μs. A transmission burst 202, 204, for example a transmission burst sent out by transmitter 122 of FIG. 1a, 1b, is sent in every eighth slot, for example in every slot with number “1”. Every active slot of a duration of 577 μs is followed by the equivalent of 7 slots (4038 μs) without transmission.

Transmission of bursts 202, 204 may cause interference in a receiver, for example in a nearby receiver configured to receive an OFDM transmission, for example in receiver 102 of FIG. 1a, 1b.

FIG. 3 shows the relation of the transmission bursts of FIG. 2 to symbols 302 of an OFDM system. The OFDM system may be a DVB-T or a DVB-H system. It may further be a Digital Multimedia Broadcasting (DMB) system, a Wireless Local Area Network (W-LAN) system, a Worldwide Interoperability for Microwave Access (Wi-MAX) system, an Ultra-Wide Band (UWB) system, or any other system using orthogonal frequency-division multiplexing.

The OFDM symbol length may be longer than a time slot of the TDMA system. For example, in an 8k-mode of the DVB-T or DVB-H system, an OFDM symbol 302 may have a length of 896 μs. A guard interval may be added to the OFDM symbol length, so that OFDM symbols may be up to 1120 μs apart. Thus, a transmission in a TDMA transmission burst may only interfere with a part of an OFDM symbol 302. In an example embodiment, a slot of the GSM system has a duration of 577 μs, which is approximately half the data part of the OFDM symbol in 8k-mode. As GSM transmission may occur in every 8^{th} slot. Thus, on average every 4^{th} OFDM symbol may be affected by a GSM transmission burst.

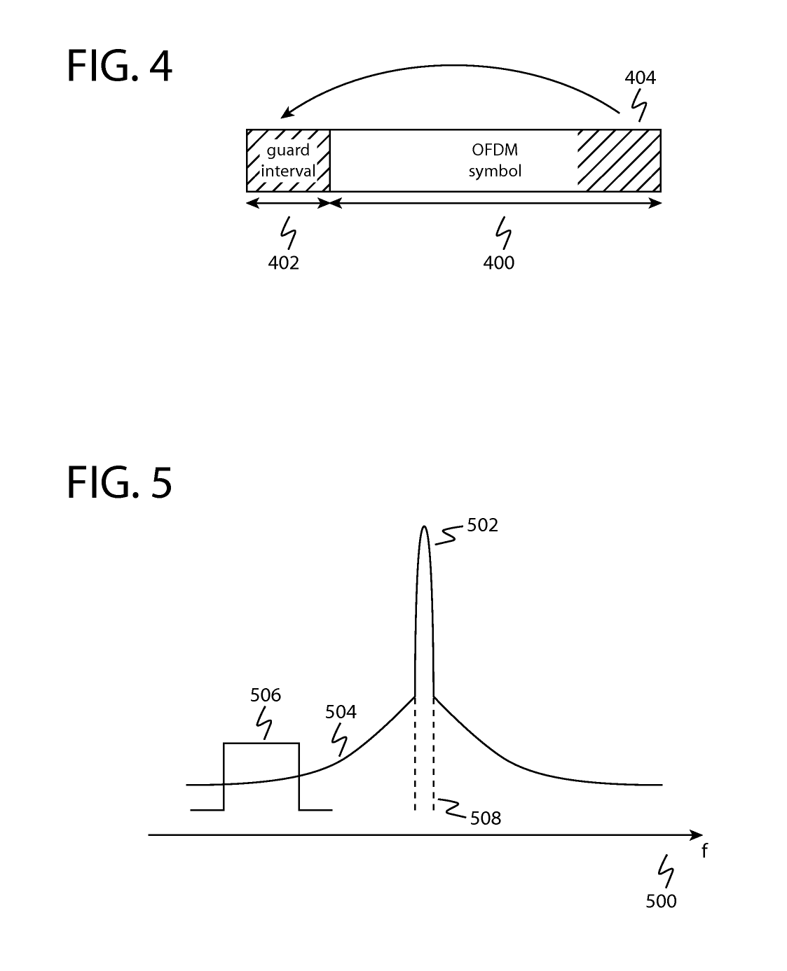

FIG. 4 shows an example embodiment of an OFDM symbol 400 with a related guard interval 402. In an example embodiment, the guard interval is the time between two transmission bursts. In an example embodiment, the guard interval precedes the OFDM symbol. For example, DVB-T and DVB-H specify a 2k-mode and an 8k-mode with a symbol duration of 224 μs and 896 μs, respectively. For DVB-H, a 4k-mode with a symbol duration of 448 μs is specified in addition to the 2k- and 4k-modes. Further parameters may specify the different modes. For each mode in a DVB-T or DVB-H system, the guard interval may be ¼, ⅛, 1/16 or 1/32 of the duration of an OFDM symbol. At least a part of the OFDM symbol may be repeated during at least a part of the guard interval. Thus, at least a part of the guard interval may comprise a copy of a part of the OFDM symbol, for example a part copied from the end of the OFDM symbol opposite the guard interval. In a further example embodiment, the part repeated from the opposite end of the OFDM symbol is selected in such a way that it connects to the beginning of the OFDM symbol with few or no phase jumps. In another example embodiment, the guard interval comprises the end 404 of the OFDM symbol 400.

FIG. 5 shows an example spectrum of an interference situation between a transmitter of a cellular system, for example a GSM system, and a receiver of a broadcast system. Along the horizontal axis the frequency f is shown. The spectrum of the signal from the transmitter may show a narrow peak 502 of a wanted signal inside a GSM transmission channel 508 and broadband noise 504 outside the GSM transmission channel 508, produced for example by a cellular amplifier in an apparatus during a cellular burst transmission. A wanted channel 506 of the broadcast system may be located close to the transmission channel of the transmitter. Reception of a signal from the broadcast system in the wanted channel 506 may be compromised by the broadband noise 504.

For example in the USA, a channel for a DVB-H service is allocated at frequency band of 1670 to 1675 MHz. In Europe, a frequency band allocation for the DVB-T and DVB-H service extends from 470 to 862 MHz in the ultrahigh frequency (UHF) band. It is also possible that future implementations in Europe and in the USA may utilize frequencies in higher or lower UHF frequencies as well. The frequency allocations are problematic in the terminal since the cellular operation may cause interference with the DVB-H reception, for example, if both of these services are operated simultaneously. For example, broadband noise of a transmitter operating in a GSM 900 or Extended GSM (E-GSM) system (the transmission frequency range in these systems extends from 880 MHz to 890 MHz (E-GSM) or from 890 MHz to 915 MHz (GSM 900)) may desensitize the uppermost DVB-T/H reception channels in Europe, and broadband noise of PCS band transmission (1850 to 1990 MHz) may desensitize the DVB-H reception in the USA.

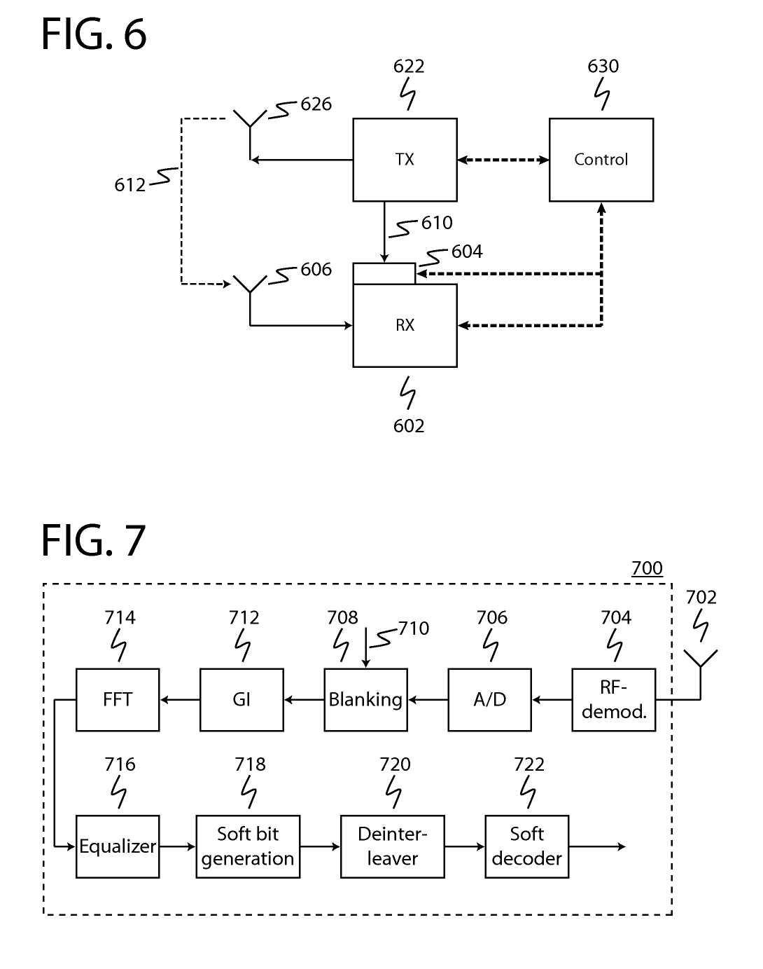

FIG. 6 shows an example embodiment of a transmitter 622 in close vicinity to a receiver 602 configured to receive a transmission, for example an OFDM transmission. In an example embodiment, receiver 602 is part of an apparatus which also comprises transmitter 622, for example apparatus 101 of FIG. 1b. Transmitter 622 generates a signal that is transmitted from antenna 626. The transmitted signal may cause interference by coupling 612 of a radiation of the transmitted signal into the receiver 602, for example by coupling of broadband noise through antenna 606. Coupling may also be caused by unwanted radiation from transmitter 622 or components from transmitter 622 into receiver 602 or components of receiver 602.

Receiver 602 may comprise a detection unit 604 which is configured to detect the presence of a burst interference. In an example embodiment, detection unit 604 detects an activity level of a signal 610 from transmitter 622 indicating a burst transmission. In another embodiment, detection unit 604 may detect a burst interference by detecting a signal strength of a radio frequency (RF) transmission with a receiver. In a further embodiment, control signals from a common control unit 630, for example a microprocessor or microcontroller, may be used to detect the presence of a burst interference. For example, control unit 630 sends information messages to detection unit 604 informing the detection unit that a command is sent to the transmitter 622 to start/stop transmission through antenna 626. The information messages may further comprise the information related to the timing of the transmission by transmitter 622.

FIG. 7 shows a block diagram of an OFDM receiver 700 according to an example embodiment of the invention. An RF signal is received, for example at antenna 702, and fed into RF-demodulator 704. RF-demodulator 704 may perform a down-conversion of the antenna signal, for example by a frequency mixing operation. The demodulated signal is A/D-converted in an analog-digital (A/D)-converter 706. The signal from the A/D-converter 706 is blanked at block 708. The blanked signal or samples of the blanked signal may be set to zero at times when a burst interference is detected, for example as indicated by a signal 710 from detection unit 604 of FIG. 6. Samples received at times when a burst interference is detected may be unreliable and may have a negative effect on the decoding. By blanking these samples, the negative effect may be erased. At block 712 the guard interval (GI) is extracted from the blanked signal, and at least a part of the signal occurring during the burst interference may be replaced with at least a part of the signal from the guard interval. In an example embodiment, only a section of the part of the OFDM symbol occurring during the burst interference is replaced with at least a part of the signal received during the guard interval, for example if the part of the OFDM symbol affected by the burst interference is larger than the guard interval.

In another example embodiment, the burst interference is detected at an end of the OFDM symbol, and the signal from the guard interval is used to replace the end of the OFDM symbol. In such an embodiment, the part affected by the burst interference may not further be determined.

The signal including the replaced part is then fed to a Fast Fourier Transform (FFT) block 714 for transformation and equalized at block 716 in order to cope with different attenuation of different channels of the OFDM signal. Soft bits are generated from the transformed signal at soft bit generation block 718 for evaluating the reliability of the received digital signal. The soft bits are deinterleaved at block 720 and decoded at block 722.

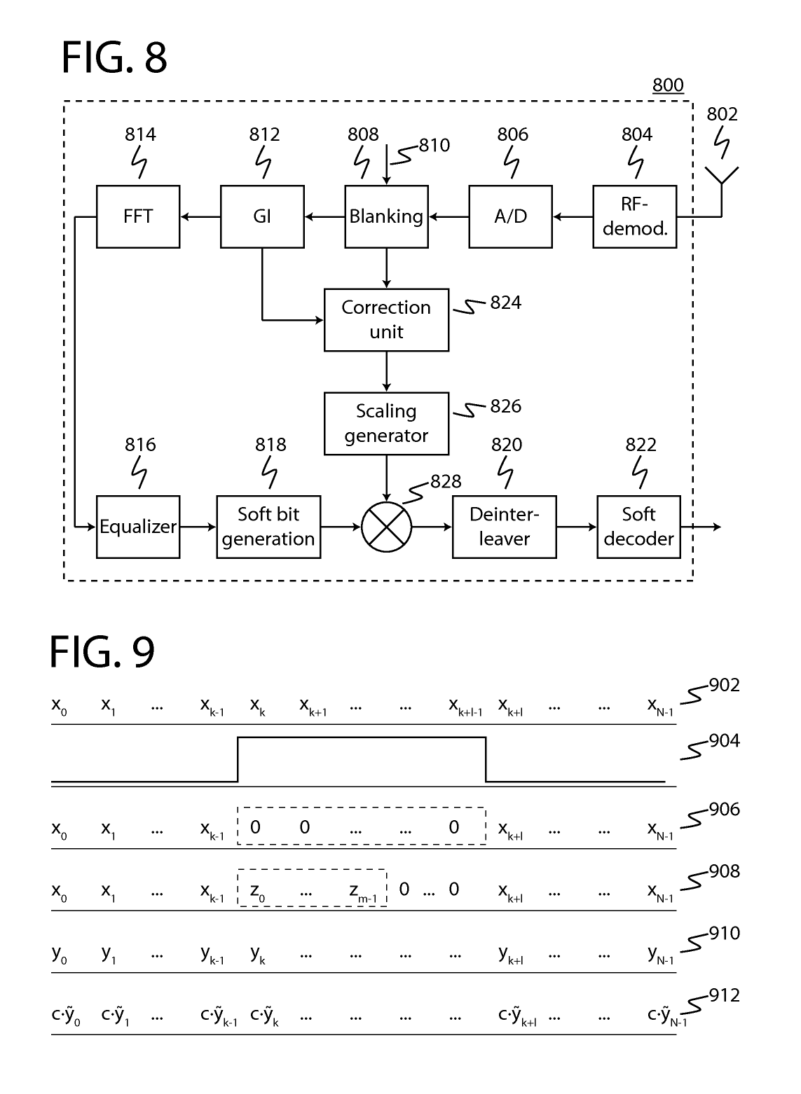

FIG. 8 shows a block diagram of an OFDM receiver 800 according to another example embodiment of the invention. Similar to FIG. 7, an RF signal is received, for example at antenna 802, and fed into RF-demodulator 804. The demodulated signal is A/D-converted in A/D-converter 806. The signal from the A/D-converter 806 is blanked at block 808 at times when a burst interference is detected, for example as indicated by a signal 810 from detection unit 612 of FIG. 6. At block 812 the guard interval (GI) is extracted from the blanked signal, and at least a part of the signal occurring during the burst interference is replaced with at least a part of the signal from the guard interval. In an example embodiment, only a section of the part of the OFDM symbol occurring during the burst interference is replaced with at least a part of the signal received during the guard interval, for example if the part of the OFDM symbol affected by the burst interference is larger than the guard interval.

In another example embodiment, the burst interference is detected at an end of the OFDM symbol, and the signal from the guard interval is used to replace the end of the OFDM symbol. In such an embodiment, the part affected by the burst interference may not further be determined.

The signal including the replaced part is then fed to a Fast Fourier Transform (FFT) block 814 for transformation. The transformed signal is equalized at block 816 and a “soft decision” is made at block 818.

The blanking block 808 further puts out a signal indicating the number of blanked samples. The number of blanked samples is corrected at correction unit 824 for the number of samples that were replaced by the guard interval at block 812. Thus, at correction unit 824, the number of still remaining blanked samples in the signal after block 812 is calculated. A soft-bit scaling factor is generated in the scaling generator block 826 based on the corrected number of blanked samples. The soft-bit scaling factor may represent the reliability of the OFDM symbol. The generated soft-bits of the OFDM symbol from block 818 are scaled by the generated soft-bit scaling factor at block 828. Finally, the multiplied soft-bits are deinterleaved at block 820 and decoded at soft decoder block 822.

In an example embodiment, a processing unit may be configured to perform at least the tasks of the Fast Fourier Transform of block 814 and the scaling operation of block 828. The processing unit may further be configured to perform the tasks of the equalizer block 816 and the soft bit generation block 818. In a further example embodiment, the processing unit may perform all the functions after A/D-conversion at block 806.

In an example embodiment, the RF-demodulator 704, 804 is placed after the A/D converter, for example if demodulation is performed on a digital signal.

In an example embodiment of the invention, the guard interval replacement in block 712, 812 is performed only if the end of the symbol opposite the guard interval is blanked. In a further example embodiment, the whole guard interval is used for the replacement if at least one of the symbols at or near the end opposite the guard interval is blanked. Thus, block 712, 812 does not consider the samples individually.

FIG. 9 shows a signal at example processing stages of a receiver according to an embodiment of the invention. Signal 902 may represent samples of a symbol after A/D-converter 806. The signal from A/D-converter may further be decimated to the number N of samples xᵢ matching the FFT size, for example 8192 samples in 8k-mode. Signal 904 indicates the timing of a burst interference. Signal 904 may correspond to signal 810 of FIG. 8 from the detection unit. Signal 906 shows the symbol after blanking at block 808. Sample xₖ to sample xₖ₊₁₋₁ (l samples) are blanked or set to zero. From these l samples, m samples (m≦l) are replaced with samples z₀ . . . zₘ₋₁ from the guard interval as shown in signal 908. The guard interval may be removed, and the signal is transformed in a Fast Fourier Transformation at block 814 to N corresponding samples y₀ . . . y_{N-1} of signal 910. Samples yᵢ may further be processed in blocks 816, 818 to samples \tilde{y}ᵢ. At block 826 the number of remaining blanked samples is calculated as l−m. A soft-bit scaling factor c is generated from this value and multiplied at block 828 to generate signal 912 of samples c*\tilde{y}₀ . . . c*\tilde{y}_{N-1}.

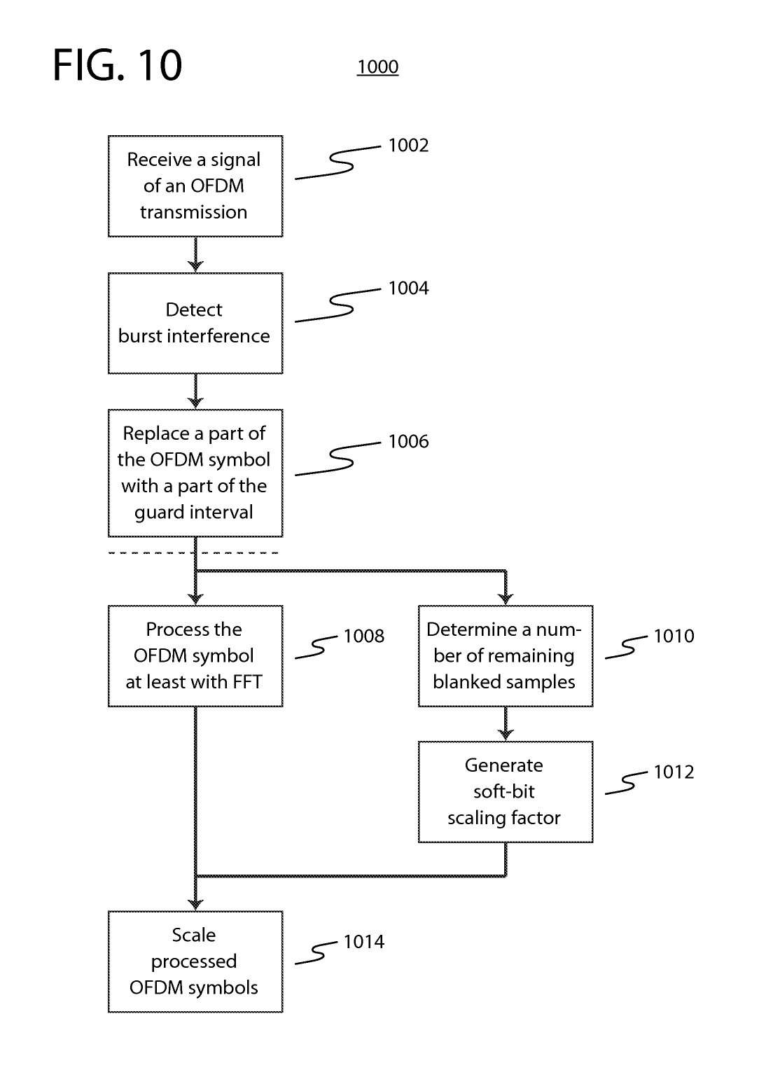

FIG. 10 shows a flowchart of a process 1000 for an example embodiment of the invention. At block 1002, a signal of an OFDM transmission is received. The signal may comprise at least one or more OFDM symbols and one or more guard intervals. The guard intervals or at least a part of a guard interval may comprise a copy of at least a part of the OFDM symbol, for example a copy of a part from an end of the symbol opposite the guard interval as shown in FIG. 4. At block 1004, a burst interference is detected. The burst interference may indicate that the signal of the OFDM transmission may be unusable. In an example embodiment, the presence of a burst interference is detected from a signal of a transmitter indicating when the transmitter is active. In another example embodiment, the presence of a burst interference is only detected if it occurs at an end of the OFDM transmission, for example an end opposite the guard interval comprising the copy of the part of the OFDM symbol.

In an example embodiment, at least a part of the samples of the signal received during the burst interference may be blanked, for example if an interference is detected at block 1004.

At block 1006 at least a part of the OFDM symbol occurring during the burst interference is replaced with at least a part of the signal received during the guard interval. In an example embodiment, all samples from the guard interval are used to replace at least a part of the samples of the OFDM symbol. In another example embodiment, only a section of the part of the OFDM symbol occurring during the burst interference is replaced with at least a part of the signal received during the guard interval. For example, only blanked samples or a section of the blanked samples of the OFDM symbol are replaced with samples from at least a part of the signal received during the guard interval.

In an example embodiment, process 1000 may continue at blocks 1008 and 1010.

At block 1008, the OFDM symbol is processed at least with a Fast Fourier Transform (FFT). In an example embodiment, the transformed OFDM symbol may be further processed by an equalizer, as in block 816 of FIG. 8. In another example embodiment, soft bits may be generated from the transformed OFDM symbol, as in block 818 of FIG. 8.

At block 1010, a number of remaining blanked samples is determined. Remaining blanked samples are samples of the OFDM symbol that were received during the burst interference and that were not replaced by samples of the signal received during the guard interval. At block 1012, a soft-bit scaling factor is generated from the number of remaining blanked samples. The soft-bit scaling factor may be generated by dividing the number of remaining blanked samples by the total number of samples of the OFDM symbol.

At block 1014, the processed OFDM symbols from block 1008 are scaled with the soft-bit scaling factor from block 1012, for example with soft-bit scaling factor c as described in relation to FIG. 9.

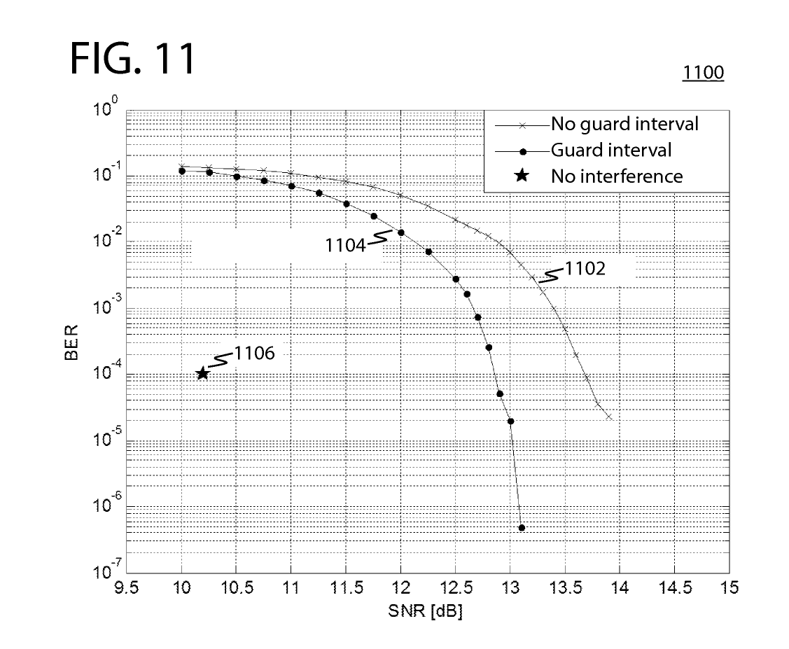

FIG. 11 shows a graph 1100 of a simulation result of an apparatus according to an example embodiment of the invention in comparison to a conventional receiver. The curves show the performance of a receiver in an 8k-mode with the guard interval having a length of ¼ of a symbol. The upper curve 1102 marked with “x” shows the dependency of the bit error rate (BER) from the signal to noise ratio (SNR) in a receiver using blanking and soft-bit scaling. The lower curve 1104 marked with dots shows the same dependency for a receiver further using the guard interval replacement according to an embodiment of the invention, for example at block 812 in the receiver of FIG. 8. The star 1106 at an SNR of 10.2 and a BER of 10⁻⁴ shows the performance of the receiver if no burst interference is present. The graphs of FIG. 11 show that embodiments of the invention using the guard interval may require a lower SNR (of approximately 0.7-0.9) to achieve the same BER as a conventional receiver. The performance improvement may be lower for shorter guard intervals.

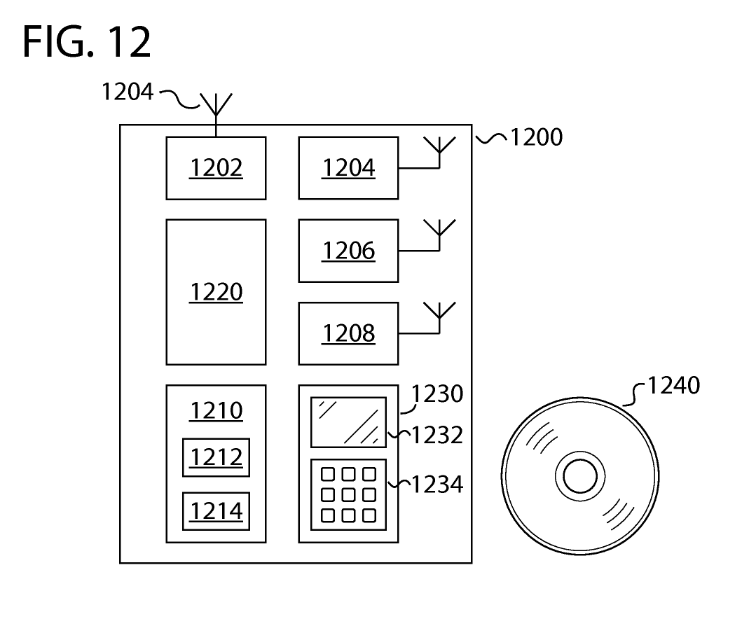

FIG. 12 shows an apparatus 1200 comprising an OFDM receiver according to an example embodiment of the invention. Apparatus 1200 may be an embodiment of apparatus 100, 101 from FIGS. 1a, 1b. Apparatus 1200 comprises a receiver 1202 configured to receive an OFDM transmission. Receiver 1202 may be coupled to an antenna 1204. Apparatus 1200 further comprises a detection unit configured to detect the presence of a burst interference. Apparatus 1200 may also comprise a control unit configured to replace a part of an OFDM symbol occurring during the burst interference with at least a part of a signal received during a guard interval. The detection unit and the control unit may be implemented in software configured to run on a processor 1220. The processor may be a microprocessor, a microcontroller, a digital signal processor or the like. Software for running apparatus 1200 may be stored in a storage or memory 1210. For example, software for running the control unit and detection unit may be stored in areas 1212 and 1214 of memory 1210. Memory 1210 may comprise volatile memory, for example random access memory (RAM), and non volatile memory, for example read only memory (ROM), FLASH memory, or the like. Memory 1210 may comprise one or more memory components. Memory 1210 may also be embedded with processor 1220. Software comprising data and instructions to run apparatus 1200 may also be loaded into memory 1210 from an external source. For example, software may be stored on an external memory like a memory stick comprising one or more FLASH memory components, a compact disc (CD), a digital versatile disc (DVD) 1240, or the like. Software or software components for running apparatus 1200 may also be loaded from a remote server, for example through the internet.

Apparatus 1200 may also comprise one or more cellular transceivers 1204, one or more local area transceivers 1206, for example a Bluetooth™ or wireless local area network (W-LAN) transceiver, a “wireless fidelity” (WiFi) transceiver, or the like. The detection unit, when run on processor 1220, may be informed by cellular transceivers 1204 and/or local area transceivers 1206 about ongoing burst transmissions that may cause interference in the reception of receiver 1202. For example, cellular transceivers 1204 and/or local area transceivers 1206 may provide a signal indicating when a transmitter of transceivers 1204 and 1206 is transmitting.

In an example embodiment, apparatus 1200 comprises a receiver 1208 configured to detect a high radio signal field strength. Receiver 1208 may provide a signal indicating when a detected radio signal field strength within a transmission band that may cause interference to receiver 1202 is above a threshold. The provided signal may be used by the detection unit, when run on processor 1220, to detect the presence of a burst interference. Processor 1220 may process a signal from receiver 1202 according to an example process of the invention, for example according to the process of FIG. 10.

Embodiments of the invention may also work with other symbols than OFDM symbols, for example if the symbol time is longer than the burst time of the burst interference and if a copy of at least a part of the symbol is transmitted at a time before or after the symbol, such as a guard time or guard interval related to that symbol.

Without in any way limiting the scope, interpretation, or application of the claims appearing below, a technical effect of one or more of the example embodiments disclosed herein is increasing the robustness of an OFDM receiver against interference from a burst transmitter. Another technical effect of one or more of the example embodiments disclosed herein is a reduced bit error rate of the received OFDM signal for a comparable signal to noise ratio. Another technical effect of one or more of the example embodiments disclosed herein is an improved performance of digital television receivers in handheld multimedia devices comprising a cellular transceiver.

Embodiments of the present invention may be implemented in software, hardware, application logic or a combination of software, hardware and application logic. The software, application logic and/or hardware may reside on an apparatus or an accessory to the apparatus. For example, the receiver may reside on a mobile TV accessory coupled to a mobile phone. If desired, part of the software, application logic and/or hardware may reside on an apparatus, part of the software, application logic and/or hardware may reside on an accessory. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1.-21. (canceled)

22. An apparatus, comprising:
a receiver configured to receive an orthogonal frequency division multiplexing (OFDM) transmission;
wherein the OFDM transmission comprises at least one OFDM symbol and at least one guard interval;
wherein at least a part of the OFDM symbol is repeated during at least a part of the guard interval;
a detection unit configured to detect a burst interference; and
a control unit configured to replace at least a part of the OFDM symbol occurring during the burst interference with at least a part of the signal received during the guard interval.

23. The apparatus of claim 22, further comprising a transmitter configured to start a burst transmission causing the burst interference.

24. The apparatus of claim 22, wherein the detection unit is further configured to detect the burst interference from a signal of a transmitter indicating when the transmitter is active.

25. The apparatus of claim 22, wherein the burst interference is a burst transmission of a transmitter of a mobile cellular system.

26. The apparatus of claim 22, wherein the receiver is a digital video broadcasting (DVB) receiver.

27. The apparatus of claim 22, wherein the detection unit is configured to detect the burst interference only at an end of the OFDM symbol; and
wherein the control unit is configured to replace the end of the OFDM symbol with the signal received during the guard interval.

28. The apparatus of claim 22, wherein only a section of the part of the OFDM symbol occurring during the burst interference is replaced with at least a part of the signal received during the guard interval.

29. The apparatus of claim 22, further comprising a blanking unit configured to blank at least the part of the OFDM symbol occurring during the burst interference.

30. The apparatus of claim 29, wherein the blanking unit is configured to put out a signal indicating a number of blanked samples, further comprising:
a correction unit configured to determine a number of remaining blanked samples of the OFDM symbol after the replacement of at least the part of the OFDM symbol occurring during the burst interference by the control unit,
a scaling generator configured to generate a soft-bit scaling factor from the determined number,
a processing unit configured to process the OFDM symbol at least with a Fast Fourier Transformation, wherein the processing unit is further configured to scale the processed OFDM symbol with the soft-bit scaling factor.

31. A method, comprising:
receiving an orthogonal frequency division multiplexing (OFDM) transmission comprising at least one OFDM symbol and at least one guard interval;
wherein at least a part of the OFDM symbol is repeated during at least a part of the guard interval;
detecting a burst interference; and
replacing at least a part of the OFDM symbol occurring during the burst interference with at least a part of the signal received during the guard interval.

32. The method of claim 31, wherein the burst interference is detected from a signal of a transmitter indicating when the transmitter is active.

33. The method of claim 31, wherein the burst interference is a burst transmission of a mobile cellular system.

34. The method of claim 31, wherein the OFDM transmission is a digital video broadcasting (DVB) transmission.

35. The method of claim 31, further comprising:
detecting the presence of a burst interference only at an end of the OFDM symbol; and
replacing the end of the OFDM symbol with the signal received during the guard interval.

36. The method of claim 31, wherein only a part of the OFDM symbol occurring during the burst interference is replaced with at least a part of the signal received during the guard interval.

37. The method of claim 31, further comprising:
blanking at least a part of the OFDM symbol occurring during the burst interference.

38. The method of claim 37, further comprising:
determining a number of remaining blanked samples of the OFDM symbol after the replacement of at least the part of the OFDM symbol occurring during the burst interference,
generating a soft-bit scaling factor from the determined number,
processing the OFDM symbol at least with a Fast Fourier Transformation, and
scaling the processed OFDM symbol with the soft-bit scaling factor.

39. A computer program, comprising:
code for receiving an orthogonal frequency division multiplexing (OFDM) transmission comprising at least one OFDM symbol and at least one guard interval;
wherein at least a part of the OFDM symbol is repeated during at least a part of the guard interval;
code for detecting a burst interference; and
code for replacing at least a part of the OFDM symbol occurring during the burst interference with at least a part of the signal received during the guard interval;
when the computer program is run on a processor.

40. The computer program according to claim 39, wherein the computer program is a computer program product comprising a computer-readable medium bearing computer program code embodied therein for use with a computer.

41. A computer-readable medium encoded with instructions that, when executed by a computer, perform:
receiving a signal of an OFDM transmission comprising at least one OFDM symbol and at least one guard interval;
wherein at least a part of the OFDM symbol is repeated during at least a part of the guard interval;
detecting the presence of a burst interference; and
replacing at least a part of the OFDM symbol occurring during the burst interference with at least a part of the signal received during the guard interval.
